(19) United States
(12) Patent Application Publication
(10) Pub. No.: US 2025/0271668 A1
(43) Pub. Date: Aug. 28, 2025

(54) HEAD-UP DISPLAY DEVICE AND METHOD OF CONTROLLING DISPLAY PERFORMED BY HEAD-UP DISPLAY DEVICE

(71) Applicant: Nippon Seiki Co., Ltd., Niigata (JP)

(72) Inventors: Yukihisa Hoshi, Niigata (JP); Yuji Inosaka, Niigata (JP); Yuri Sato, Niigata (JP)

(21) Appl. No.: 19/037,045

(22) Filed: Jan. 24, 2025

(30) Foreign Application Priority Data
Feb. 26, 2024 (JP) 2024-026156

(51) Int. Cl. G02B 27/01

(52) U.S. Cl. CPC G02B 27/0101

(57) ABSTRACT

A head-up display device includes an imaging optical system with a first reflection member, differing in transmittance between two polarization states, and a second reflection member. Display light in the first polarization state forms a virtual image via the first reflection member, while light in the second polarization state forms a real image via the second reflection member. A control unit manages the polarization state and toggles the backlight's light sources. When displaying a virtual image, the control unit activates at least one light source, and for a real image, it activates at least one light source with higher power consumption than for the virtual image.

### TECHNICAL FIELD

The present invention relates to a head-up display device that has an emission port and emits display light from the emission port toward a light-transmissive member and thereby causes a virtual image and a real image of a display image represented by the display light to be visually recognized, and the like.

### BACKGROUND ART

A known head-up display device emits display light from an emission port toward a light-transmissive member and thereby causes a virtual image and a real image of a display image represented by the display light to be visually recognized. For example, in a head-up display device proposed in Patent Document 1, in a structure in which a display image displayed on a screen with light from a display unit is reflected toward a light-transmissive member, a front-rear positional relationship between an optical focus of an imaging optical system and the screen is changed to switch the display between a state in which a virtual image is visually recognized outside the light-transmissive member and a state in which a real image is visually recognized inside the light-transmissive member (see paragraphs [0008] to [0014] and FIGS. 2A and 2B of Patent Document 1).

In the head-up display device having such a structure, when the display is switched to the real image visual recognition state, appropriate luminance and uniformity ratio of illumination cannot be obtained, and when adjustment is performed to obtain appropriate luminance and uniformity ratio of illumination in the real image visual recognition state, the luminance and uniformity ratio of illumination in the virtual image visual recognition state become inappropriate. Thus, for example, Patent Document 2 (unpublished at the filing date of the present application) describes a head-up display device capable of switching the display between virtual image display and real image display by performing switching between a lenticular lens for a virtual image visual recognition state and a lenticular lens for a real image visual recognition state, achieving a good luminance and uniformity ratio of illumination both in the virtual image visual recognition state and the real image visual recognition state (see paragraph [0008] and FIGS. 5 to 9 of Patent Document 2).

### PRIOR ART DOCUMENT

### Patent Document

Patent Document 1: Japanese Unexamined Patent Application Publication No. 2011-70074
Patent Document 2: Japanese Patent Application No. 2023-046171

### SUMMARY OF INVENTION

### Technical Problem

The technique described in Patent Document 2 achieves a good luminance and uniformity ratio of illumination both in the virtual image visual recognition state and the real image visual recognition state; however, if the brightness of a backlight is the same when the display image is switched to the virtual image and when the display image is switched to the real image, due to different characteristics of the virtual image display and the real image display in light distribution from a display unit, there is a difference in brightness between the virtual image display and the real image display. In particular, the inventors have recognized that the brightness in the real image display is lower than in the virtual image display.

It is known that the above phenomenon is based on the following matter. That is, for example, as illustrated in light distribution characteristics for a virtual image in FIGS. 7A and 7B, the virtual image display requires light distribution characteristics with a widened optical axis range in both a vertical direction (V direction) and a horizontal direction (H direction) (light sources of a backlight emit illumination light so that the illumination light is diverged to a display unit), and as illustrated in light distribution characteristics for a real image in FIGS. 7C and 7D, the real image display requires light distribution characteristics with a narrowed optical axis range in both the vertical direction (V direction) and the horizontal direction (H direction) (the light sources of the backlight emit illumination light so that the illumination light is converged to the display unit). When a virtual image or a real image is displayed with the light distribution characteristics illustrated in FIGS. 7A, 7B, 7C, and 7D, the virtual image is displayed with appropriate luminance and uniformity ratio of illumination, but the real image is not displayed with appropriate light distribution characteristics, and thus appropriate luminance and uniformity ratio of illumination cannot be ensured. The light distribution characteristics can be adjusted by changing the structure of a lens group; however, it is difficult to design a lens optimized for both a virtual image and a real image, and thus a lens group optimized for a virtual image cannot ensure appropriate luminance and uniformity ratio of illumination during the real image display (see paragraphs to of Patent Document 2).

Therefore, an object of the present invention is to provide a head-up display device capable of achieving a small difference in brightness at the time of switching between virtual image display and real image display in a case where a display unit and a plurality of light sources of a backlight are used to perform the virtual image display and the real image display.

Other objects of the present invention will become apparent to those skilled in the art by referring to the aspects and best mode exemplified below, and the accompanying drawings.

### Solution to Problem

In order to facilitate understanding of the outline of the present invention, aspects according to the present invention will be exemplified.

A first aspect according to the present invention is a head-up display device that has an emission port and emits display light from the emission port toward a light-transmissive member and thereby causes a virtual image and a real image of a display image represented by the display light to be visually recognized, the head-up display device including: an imaging optical system that includes a display unit, a backlight including a plurality of light sources, a first reflection member having, as a polarization state, a first polarization state and a second polarization state different from each other in transmittance, and a second reflection member reflecting the display light transmitted through the first reflection member and in which first display light in the first polarization state is emitted through a first optical path reflected by a surface of the first reflection member and forms the virtual image and second display light in the second polarization state is transmitted through the first reflection member, is emitted through a second optical path reflected by the second reflection member, and forms the real image; and a control unit that controls the polarization state and controls turning on and off of each of the plurality of light sources of the backlight, wherein when the virtual image is displayed, the control unit performs control so that at least one of the plurality of light sources of the backlight is turned on, and when the real image is displayed, the control unit performs control so that at least one of the plurality of light sources of the backlight is turned on and more power is consumed by the plurality of light sources of the backlight than when the virtual image is displayed.

The head-up display device of the first aspect includes the imaging optical system that includes the first reflection member having, as a polarization state, the first polarization state and the second polarization state different from each other in transmittance and the second reflection member reflecting the display light transmitted through the first reflection member and in which the display light in the first polarization state is emitted through the first optical path reflected by the surface of the first reflection member and forms the virtual image and the display light in the second polarization state is transmitted through the first reflection member, is emitted through the second optical path reflected by the second reflection member, and forms the real image, and the control unit that controls the polarization state of the imaging optical system. When the virtual image is displayed, the control unit performs control so that at least one of the plurality of light sources of the backlight is turned on, and when the real image is displayed, the control unit performs control so that at least one of the plurality of light sources of the backlight is turned on and more power is consumed by the plurality of light sources of the backlight than when the virtual image is displayed.

For example, in a case where light-emitting diodes (LEDs) are mounted as the plurality of light sources of the backlight, the control unit can achieve higher power efficiency by controlling the ON/OFF timing of each of the LEDs and a value (current value) of a current flowing through the LEDs and controlling a voltage supplied to the backlight by an LED drive circuit (e.g., a light source driving unit 133 in FIG. 2). Thus, in the head-up display device that is capable of performing switching between the virtual image display and the real image display and in which the display unit and the plurality of light sources of the backlight are used to perform the virtual image display and the real image display, by performing control so that more power is supplied to the backlight when the display is switched from the virtual image display to the real image display, it is possible to achieve a small difference in brightness at the time of switching between the virtual image display and the real image display, reducing the discomfort experienced by an occupant as a viewer, ensuring appropriate luminance and uniformity ratio of illumination in both the virtual image display and the real image display. Furthermore, the small difference in brightness (luminance difference) at the time of switching from the virtual image display to the real image display can reduce the discomfort experienced by an occupant as a viewer.

In a second aspect according to the first aspect, when the real image is displayed, the control unit may perform control so that a value of a current flowing through the plurality of light sources of the backlight is increased.

In the second aspect, when the display is switched from the virtual image display to the real image display, the control unit can control the value (current value) of the current flowing through the plurality of light sources (e.g., LEDs) of the backlight to increase the brightness of the backlight, achieving a small difference in brightness between the virtual image display and the real image display without increasing the area of a region in which the plurality of light sources of the backlight are turned on, thus reducing the discomfort experienced by an occupant as a viewer. In particular, it is possible to achieve high luminance during the real image display, thus ensuring appropriate luminance and uniformity ratio of illumination in both the virtual image display and the real image display.

In a third aspect according to the first or second aspect, when the real image is displayed, the control unit may perform control so that a number of light sources turned on of the plurality of light sources of the backlight is increased.

In the third aspect, when the display is switched from the virtual image display to the real image display, the control unit can increase the number (area) of light sources turned on of the backlight mounted with the plurality of light sources, achieving a small difference in brightness between the virtual image display and the real image display, thus reducing the discomfort experienced by an occupant as a viewer. In particular, it is possible to achieve high luminance during the real image display, thus ensuring appropriate luminance and uniformity ratio of illumination in both the virtual image display and the real image display.

In a fourth aspect according to any one of the first to third aspects, when the real image is displayed, the control unit may perform control so that a value of a current flowing through the plurality of light sources of the backlight is increased and performs control so that a number of light sources turned on of the plurality of light sources of the backlight is increased.

In the fourth aspect, when the display is switched from the virtual image display to the real image display, the control unit can control the value of the current flowing through the plurality of light sources (e.g., LEDs) of the backlight to increase the brightness of the backlight and can increase the number (area) of light sources turned on of the backlight mounted with the plurality of light sources, further achieving a small difference (minimizing the difference) in brightness between the virtual image display and the real image display. In particular, it is possible to achieve high luminance during the real image display, thus ensuring appropriate luminance and uniformity ratio of illumination in both the virtual image display and the real image display.

A fifth aspect according to the present invention is a method of controlling a head-up display device including an emission port, an imaging optical system that includes a backlight including a plurality of light sources, a display unit that transmits illumination light emitted by the light sources and generates a display image, a first reflection member having, as a polarization state, a first polarization state and a second polarization state different from each other in transmittance, and a second reflection member reflecting first display light transmitted through the first reflection member and in which first display light in the first polarization state is emitted through a first optical path reflected by a surface of the first reflection member and forms the virtual image and second display light in the second polarization state is transmitted through the first reflection member, is emitted through a second optical path reflected by the second reflection member, and forms the real image, and a control unit that controls the polarization state and controls turning on and off of each of the plurality of light sources of the backlight, the method including: a step of controlling, by the control unit, the polarization state and switching the display light to be emitted to the display light in the first polarization state or the display light in the second polarization state; a step of performing control, by the control unit, so that at least one of the plurality of light sources of the backlight is turned on, when the first display light in the first polarization state is emitted from the emission port and the virtual image is formed; and a step of performing control, by the control unit, so that at least one of the plurality of light sources of the backlight is turned on and more power is consumed by the plurality of light sources of the backlight than when the virtual image is formed, when the second display light in the second polarization state is emitted from the emission port and the real image is formed.

The method of controlling a head-up display device of the fifth aspect includes a control procedure (steps) in which the control unit controls the polarization state of the imaging optical system that includes the first reflection member having, as a polarization state, the first polarization state and the second polarization state different from each other in transmittance and the second reflection member reflecting display light transmitted through the first reflection member and in which display light in the first polarization state is emitted through the first optical path reflected by the surface of the polarization reflection member and forms the virtual image and display light in the second polarization state is transmitted through the first reflection member, is emitted through the second optical path reflected by the second reflection member, and forms the real image. When the display light in the first polarization state is emitted and the virtual image is formed, the control unit performs control so that at least one of the plurality of light sources of the backlight is turned on, and when the display light in the second polarization state is emitted and the real image is formed, the control unit performs control so that at least one of the plurality of light sources of the backlight is turned on and more power is consumed by the plurality of light sources of the backlight than when the display light in the first polarization state is emitted and the virtual image is formed.

Therefore, for example, in a case where LEDs are mounted as the plurality of light sources of the backlight, the control unit can achieve higher power efficiency by controlling the ON/OFF timing of each of the LEDs and the current value of the current flowing through the LED columns and controlling the voltage supplied to the backlight by an LED drive circuit (e.g., the light source driving unit 133 in FIG. 2). Thus, in the head-up display device that is capable of performing switching between the virtual image display and the real image display and in which the display unit and the plurality of light sources of the backlight are used to perform the virtual image display and the real image display, by performing control so that more power is supplied to the backlight when the display is switched from the virtual image display to the real image display, it is possible to minimize the difference in brightness at the time of switching between the virtual image display and the real image display, ensuring appropriate luminance and uniformity ratio of illumination in both the virtual image display and the real image display. Furthermore, the small difference in brightness (luminance difference) at the time of switching from the virtual image display to the real image display can reduce the discomfort experienced by an occupant as a viewer.

Those skilled in the art will readily understand that the exemplified aspects according to the present invention may be modified without departing from the spirit of the present invention.

### BRIEF DESCRIPTION OF DRAWINGS

FIG. 1 is a diagram illustrating an example of a configuration including an imaging optical system of a head-up display device according to an embodiment of the present invention.

FIG. 2 is a diagram illustrating an example of a configuration of a control system of the head-up display device according to the embodiment of the present invention.

FIG. 3 is a flowchart illustrating an example of an operation of the control system of the head-up display device according to the embodiment of the present invention.

FIG. 4 is a diagram illustrating an example of an arrangement (layout) of a plurality of light sources mounted on a backlight of the head-up display device according to the embodiment of the present invention.

FIG. 5 is a diagram illustrating an example of a light source illumination pattern of the plurality of light sources mounted on the backlight during virtual image display and during real image display of the head-up display device according to the embodiment of the present invention.

FIG. 6 is a diagram illustrating another example of the light source illumination pattern of the plurality of light sources mounted on the backlight during virtual image display and during real image display of the head-up display device according to the embodiment of the present invention.

FIG. 7 is a diagram used to illustrate light distribution characteristics during virtual image display and light distribution characteristics during real image display.

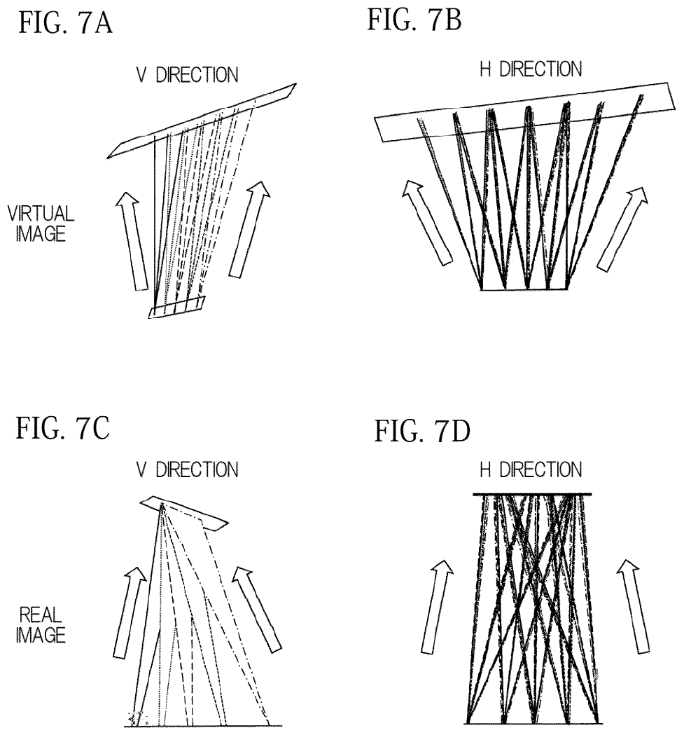

### DESCRIPTION OF EMBODIMENTS

The best mode described below is used to facilitate understanding of the present invention. Therefore, those skilled in the art should note that the present invention is not unreasonably limited by the embodiment described below (hereinafter referred to as the present embodiment).

### Configuration of Embodiment

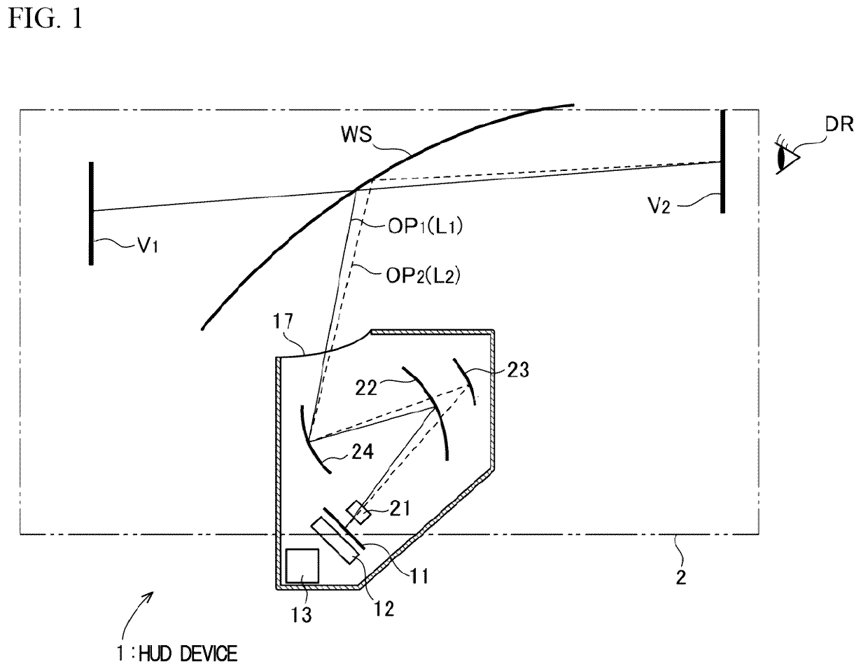

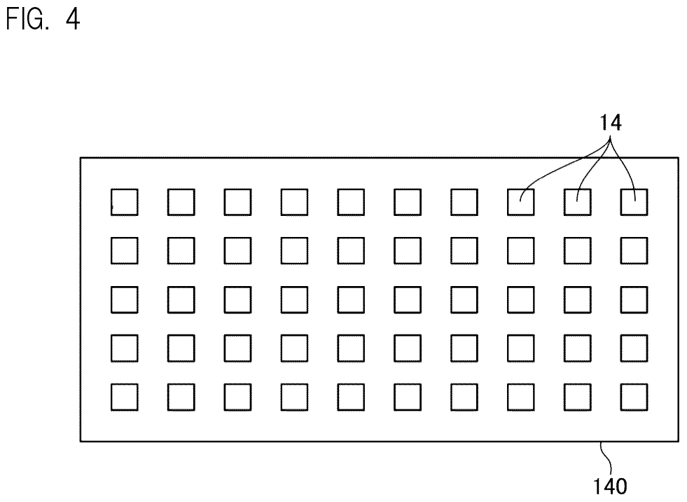

Reference is made to FIG. 1. FIG. 1 is a diagram illustrating an example of a configuration including an imaging optical system 2 of a head-up display device (hereinafter referred to as a HUD device 1 unless otherwise specified) according to the present embodiment. The HUD device 1 of the present embodiment includes, for example, light sources 14, a backlight 12, and a display unit 11. The light sources 14 are composed of, for example, LEDs, emit white light in a visible wavelength range, and are mounted on a light source circuit board 140 (see FIG. 4). The backlight 12 includes lenses (condenser lens and lenticular lens not illustrated) that concentrate light emitted by the light sources 14. The display unit 11 is composed of, for example, a liquid crystal display or the like, and generates an image with light emitted from the light sources 14, switches a polarization state of the light to be emitted between a first polarization state and a second polarization state different from each other, and generates display light L1 and L2 representing a display image. The light source circuit board 140 is connected to a control unit 13 (control circuit board) described below by a wire (not illustrated). The turning on and off of the LEDs as the light sources 14 is controlled by the control unit 13.

The HUD device 1 of the present embodiment includes a first reflection member 22, a second reflection member 23, and a third reflection member 24. The first reflection member 22 is composed of, for example, a half mirror, and has, as a polarization state, a first polarization state and a second polarization state different from each other in transmittance. The second reflection member 23 reflects the display light L1 transmitted through the first reflection member 22. The third reflection member 24 reflects, toward a windshield WS that is a light-transmissive member, display light L representing a display image displayed by the display unit 11 (display light L1 representing a display image for a virtual image V1, display light L2 representing a display image for a real image V2). In the imaging optical system 2, the display light L1 in the first polarization state is emitted through a first optical path OP1 reflected by a surface of the first reflection member 22, and forms the virtual image V1, and the display light L2 in the second polarization state is transmitted through the first reflection member 22, is emitted through a second optical path OP2 reflected by the second reflection member 23 and the third reflection member 24, and forms the real image V2.

Although an infinite number of light beams are actually emitted from the display unit 11, only representative light beams emitted from the center of the display unit 11 and passing through the center of an eye box are indicated by a solid line (virtual image V1) and a dashed line (real image V2) in order to simplify the description. The first reflection member 22 is not limited to a half mirror, and may be any member in which the first display light L1 is transmitted through one surface and the second display light L2 is reflected by the other surface. The first reflection member 22 may be, for example, a member to which a wavelength-selective film is attached, or a transmissive member with a coating. A lenticular lens 21 composed of a translucent resin material is interposed between the display unit 11 and the first reflection member 22. The lenticular lens 21 causes the display light L (L1, L2) generated and emitted by the display unit 11 to be extended in different directions, achieving higher uniformity ratio of illumination.

The display light L (L1, L2) emitted from the display unit 11 is finally projected toward the windshield WS as a light-transmissive member through an emission port 17 that is an opening provided in a housing upper portion of the HUD device 1. Therefore, an occupant DR who is a viewer in a vehicle C visually recognizes the display light L1 or L2 reflected by the windshield WS, and thus can visually recognize the virtual image V1 formed on the far side of the windshield WS (vehicle outer side with the windshield WS therebetween) and the real image V2 formed on the near side of the windshield WS (vehicle inner side with the windshield WS therebetween).

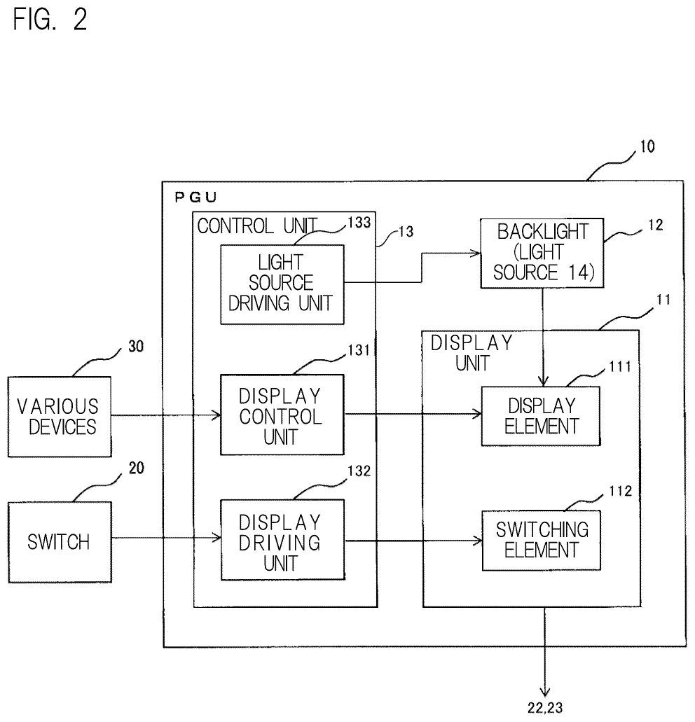

The HUD device 1 of the present embodiment further includes the control unit 13 that controls the polarization state described above and controls the turning on and off of each of the plurality of light sources (see 14 in FIG. 2, not illustrated in FIG. 1) of the backlight 12. When the virtual image V1 is displayed, the control unit 13 performs control so that at least one of the plurality of light sources 14 of the backlight 12 is turned on. When the real image V2 is displayed, the control unit 13 performs control so that at least one of the plurality of light sources 14 of the backlight 12 is turned on and more power is consumed by the plurality of light sources 14 of the backlight 12 than when the virtual image V1 is displayed. As described below, the control unit 13 can control the content displayed by the display unit 11.

Reference is made to FIG. 2. FIG. 2 is a diagram illustrating an example of a configuration of a control system of the HUD device 1 of the present embodiment. Specifically, FIG. 2 is a function configuration diagram illustrating a configuration of a picture generation unit (hereinafter referred to as a PGU 10) of the HUD device 1, and includes the control unit 13 illustrated in FIG. 1. FIG. 2 illustrates only the minimum required components directly related to the present invention, and other known components are omitted.

In FIG. 2, the PGU 10 includes the display unit 11, the backlight 12 (light sources 14), and the control unit 13. The control unit 13 includes a display control unit 131 that issues a command to the display unit 11 to generate display light L1 and L2 representing a display image, for example, based on information or a signal transmitted from various devices 30 such as a vehicle speed sensor, a navigation device, a radio detecting and ranging (radar), or a light detection and ranging (LiDAR).

Furthermore, the control unit 13 includes a display driving unit 132 that performs switching control of the polarization direction of the display unit 11 that generates an image with light emitted from the light sources 14 of the backlight 12, switches the polarization state of the light to be emitted between the first polarization state and the second polarization state different from each other, and generates display light L1 and L2 representing a display image, for example, based on a signal transmitted from a switch 20 that switches a driving mode (manual driving, automated driving) of the vehicle C.

Furthermore, the control unit 13 includes a light source driving unit 133 that controls the supply of power required to turn on and off the light sources 14 mounted on the light source circuit board 140 (see FIG. 4) of the backlight 12. The light source driving unit 133 can achieve higher power efficiency by controlling the ON/OFF timing of each of the LEDs mounted as the light sources 14 on the light source circuit board 140 and a value (current value) of a current flowing through the LEDs and controlling a voltage supplied to the light sources 14.

As described above, in the HUD device 1 that is capable of performing switching between the virtual image V1 display and the real image V2 display and in which the display unit 11 and the plurality of light sources 14 of the backlight 12 are used to perform the virtual image V1 display and the real image V2 display, by performing control by the light source driving unit 133 so that more power is supplied to the backlight 12 (light sources 14) when the display is switched from the virtual image V1 display to the real image V2 display, it is possible to achieve a small difference in brightness at the time of switching between the virtual image V1 display and the real image V2 display. Thus, the small difference in brightness (luminance difference) at the time of switching from the virtual image V1 display to the real image V2 display can reduce the discomfort experienced by the occupant DR as a viewer.

The display unit 11 includes a thin film transistor (TFT) display element 111 and a switching element 112. The display element 111 forms display light L1 and L2 representing a figure with an arbitrary shape based on a signal transmitted from the display control unit 131. The switching element 112 switches the display light L to be emitted to the display light L1 that is first polarized light or the display light L2 that is second polarized light, according to a signal transmitted from the display driving unit 132.

In the configuration in FIG. 2, for example, when manual driving is performed, the display driving unit 132 controls the switching element 112 to emit the display light L1 as first polarized light. In this case, the display control unit 131 controls the display element 111 to generate display light L1 representing vehicle information, route guidance information, warning display, or the like. Furthermore, for example, when automated driving is performed, the display driving unit 132 performs switching control of the switching element 112 to emit the display light L2 as second polarized light. In this case, the display control unit 131 controls the display element 111 to generate display light L2 representing an assistant or an agent that supports driving performed by the occupant DR, a character indicating the assistant or the agent, or the like.

Thus, in the HUD device 1 of the present embodiment, in order to display the virtual image V1, the display unit 11 that controls the polarization causes the polarization state of the backlight 12 (light sources 14) to be, for example, a polarization state in which light is reflected by the first reflection member 22 composed of a half mirror. In this case, the display light L1 is reflected by the second reflection member 23, is incident on the third reflection member 24 and further reflected by the third reflection member 24, is incident on the windshield WS as a light-transmissive member and reflected by the windshield WS, and forms the virtual image V1 that can be displayed on the vehicle outer side with the windshield WS therebetween (in an imaging region that is virtually set in front of the vehicle C and set to be inclined with respect to a road surface) (see the optical path OP1 in FIG. 1).

In contrast, in the HUD device 1 of the present embodiment, in order to display the real image V2, the display unit 11 that controls the polarization causes the polarization state of the backlight 12 (light sources 14) to be, for example, a polarization state in which light is transmitted through the first reflection member 22 composed of a half mirror. In this case, the display light L2 is reflected by the second reflection member 23, is incident on the third reflection member 24 and further reflected by the third reflection member 24, is incident on the windshield WS as a light-transmissive member and reflected by the windshield WS, and forms the real image V2 that can be displayed on the vehicle inner side on the near side of the occupant DR with the windshield WS therebetween (in an imaging region that is virtually set to be perpendicular to the road surface) (see the second optical path OP2 in FIG. 1).

That is, for example, in the imaging region for the virtual image V1 that forms an angle of less than 45 degrees with respect to the road surface, the display content appears to be developed on the road surface. Thus, the imaging region for the virtual image V1 has an advantage in that when navigation or the like is performed, the display content appears to be superimposed on the road surface, allowing intuitive presentation of information. In contrast, the imaging region for the real image V2 that forms an angle of 45 degrees or more with respect to the road surface is assumed to be used in a situation where entertainment content is watched during automated driving or vehicle stop, and has an advantage in that an image is displayed perpendicular to the road surface, achieving higher visibility.

### Operation of Embodiment

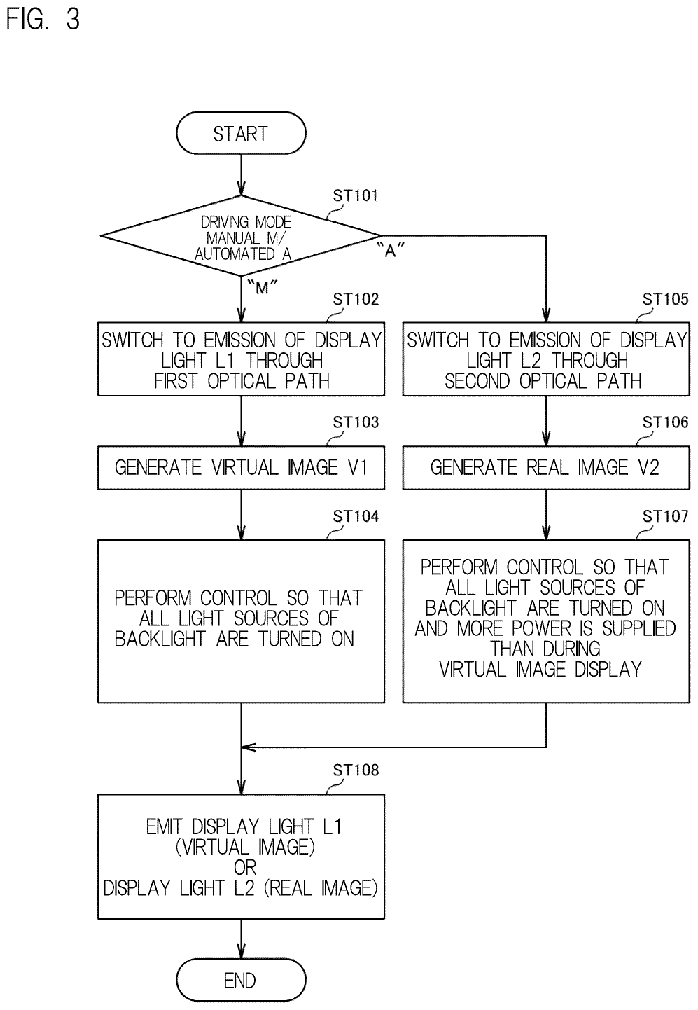

Reference is made to FIG. 3. FIG. 3 is a flowchart illustrating an example of an operation of the control system of the HUD device 1 of the present embodiment. FIG. 4 is a diagram illustrating an example of an arrangement (layout), on the light source circuit board 140, of the plurality of light sources 14 mounted on the backlight 12 of the HUD device 1 of the present embodiment. The operation of the control system (PGU 10, mainly the control unit 13) of the HUD device 1 of the present embodiment illustrated in FIG. 2 will be described in detail below with reference to FIGS. 3 and 4.

In the PGU 10, first, the control unit 13 (display driving unit 132) determines, based on a signal transmitted from the switch 20 that switches the driving mode (manual driving, automated driving) of the vehicle C, whether the vehicle Cis performing manual driving or automated driving (step ST101). When the control unit 13 (display driving unit 132) determines that the vehicle C is performing manual driving (“M” in step ST101), the control unit 13 (display driving unit 132) controls the imaging optical system 2 via the switching element 112 of the display unit 11 to emit the display light L1 as first polarized light. That is, the control unit 13 (display driving unit 132) performs switching of the imaging optical system 2 so that the display light L1 is projected from the emission port 17 toward the windshield WS through the first optical path OP1 (step ST102). In this case, the control unit 13 (display control unit 131) controls the display element 111 of the display unit 11 to generate first display light L1 (virtual image V1) representing vehicle information, route guidance information, warning display, or the like (step ST103).

Subsequently, for example, as illustrated in the example of the arrangement (layout) of the light sources 14 on the light source circuit board 140 in FIG. 4, the control unit 13 (light source driving unit 133) performs control so that at least one of the LEDs (all the LEDs in this case) as the light sources 14 is turned on (step ST104), and the display unit 11 emits (projects) the generated display light L1 (virtual image V1) toward the windshield WS as a light-transmissive member via the imaging optical system 2 (first optical path OP1) and the emission port 17 (step ST108).

In contrast, when the vehicle C is performing automated driving (“A” in step ST101), the control unit 13 (display driving unit 132) controls the imaging optical system 2 via the switching element 112 to emit the second display light L2 as second polarized light. That is, the control unit 13 (display driving unit 132) performs switching of the imaging optical system 2 so that the second display light L2 is projected from the emission port 17 toward the windshield WS through the second optical path OP2 (step ST105). In this case, the display control unit 131 controls the display element 111 to generate second display light L2 representing an assistant or an agent that supports driving performed by the occupant DR, a character indicating the assistant or the agent, or the like (step ST106).

Subsequently, for example, as illustrated in the example of the arrangement (layout) of the light sources 14 on the light source circuit board 140 in FIG. 4, the control unit 13 (light source driving unit 133) performs control so that at least one of the LEDs (all the LEDs in this case) as the light sources 14 is turned on and more power is supplied to the light sources 14 mounted on the light source circuit board 140 of the backlight 12 than during the virtual image display (step ST107). In order to control the power supplied to the light sources 14, power consumption may be increased to allow the brightness during the real image V2 display to be higher than during the virtual image V1 display, for example, by performing control so that the value (current value) of the current flowing through the plurality of light sources 14 of the backlight 12 is increased, performing control so that the number (area) of light sources 14 turned on is increased, or performing both.

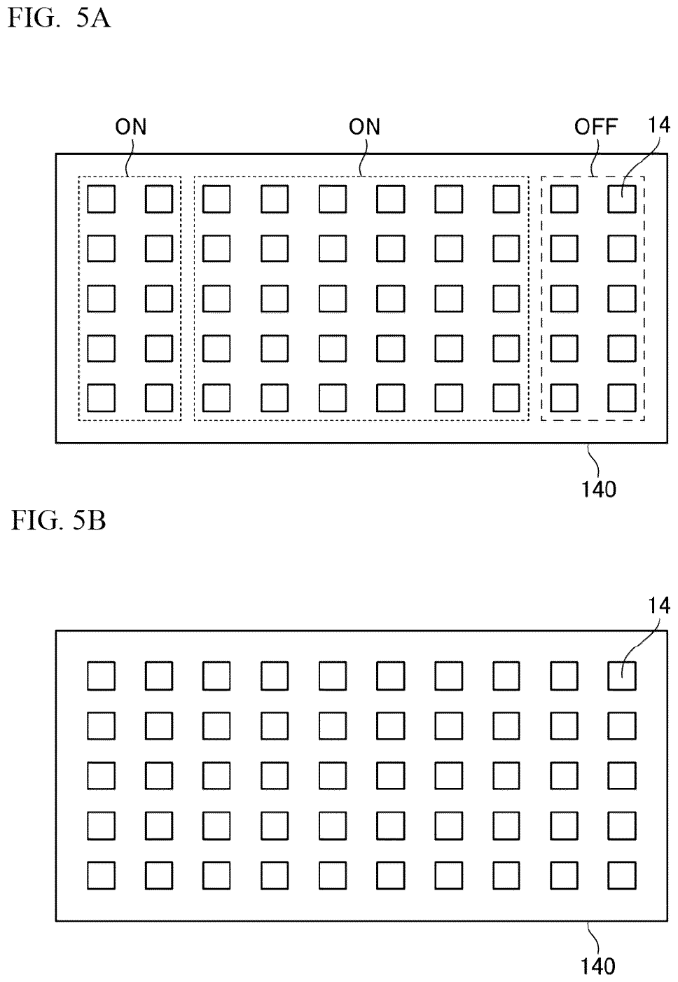

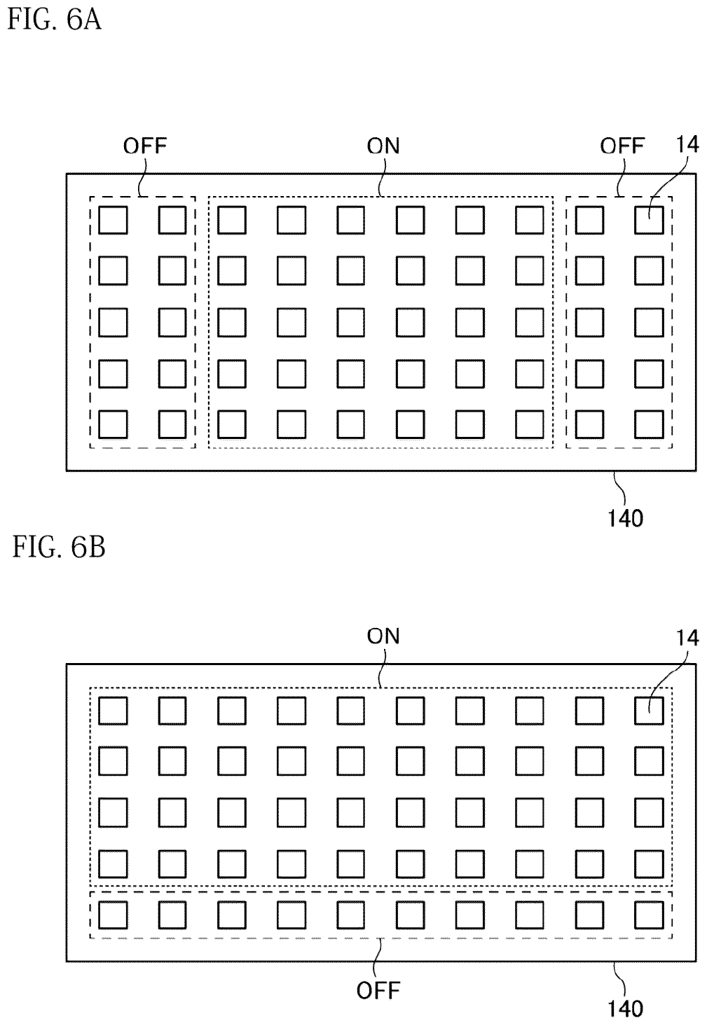

For example, as illustrated in FIGS. 5A and 5B, the control unit 13 may perform control so that at least one of the light sources 14 of the backlight 12 is turned on during the virtual image V1 display and all the light sources 14 are turned on during the real image V2 display. In this case, the brightness of each of the light sources 14 may be the same during the virtual image V1 display and during the real image V2 display, or may be higher during the real image V2 display. FIG. 5B illustrates an illumination pattern of the light sources 14 during the real image V2 display in which all the light sources 14 are turned on; however, in a case where the power consumption during the real image V2 display is higher than during the virtual image V1 display, for example, as illustrated in an illumination pattern in FIGS. 6A and 6B, the at least one of the light sources 14 turned on during the virtual image V1 display may be turned off during the real image V2 display. Details of the illumination patterns of the light sources 14 illustrated in FIGS. 5A and 5B and FIGS. 6A and 6B will be described below.

Finally, the display unit 11 emits (projects) the generated second display light L2 (real image V2) toward the windshield WS as a light-transmissive member via the imaging optical system 2 (second optical path OP2) and the emission port 17 (step ST108). Thus, in the HUD device 1 that is capable of performing switching between the virtual image V1 display and the real image V2 display and in which the display unit 11 and the plurality of light sources 14 of the backlight 12 are used to perform the virtual image V1 display and the real image V2 display, by performing control so that more power is supplied to the backlight 12 when the display is switched from the virtual image V1 display to the real image V2 display, it is possible to achieve a small difference in brightness at the time of switching between the virtual image V1 display and the real image V2 display, ensuring appropriate luminance and uniformity ratio of illumination in both the virtual image display and the real image display.

FIG. 5 illustrates an example of the light source illumination pattern of the plurality of light sources 14 mounted on the backlight 12 during the virtual image V1 display (FIG. 5A) and during the real image V2 display (FIG. 5B) of the HUD device 1 of the present embodiment. In FIGS. 5A and 5B, the light sources 14 are turned on in a light source mounting region surrounded by a dashed line and denoted by ON, and the light sources 14 are turned off in a light source mounting region denoted by OFF. In the illumination pattern of the light sources 14 during the virtual image V1 display illustrated in FIG. 5A, the light sources 14 that are arranged in two columns on the left and two columns on the right in an edge portion in a long-side direction (horizontal direction) of the light source circuit board 140 having a rectangular shape are turned off (denoted by OFF), and the light sources 14 that are arranged between the two columns on the left and the two columns on the right are turned on (denoted by ON). In contrast, in the illumination pattern of the light sources 14 during the real image V2 display illustrated in FIG. 5B, all the light sources 14 are turned on (indicated by hatching). The brightness of each of the light sources 14 in the illumination pattern of the light sources 14 during the real image V2 display illustrated in FIG. 5B may be the same as or higher than during the virtual image V1 display illustrated in FIG. 5A.

FIG. 6 illustrates another example of the illumination pattern of the plurality of light sources 14 mounted on the backlight 12 during the virtual image V1 display (FIG. 6A) and during the real image V2 display (FIG. 6B) of the HUD device 1 of the present embodiment. In FIGS. 6A and 6B, the light sources 14 are turned on in a light source mounting region surrounded by a dashed line and denoted by ON, and the light sources 14 are turned off in a light source mounting region denoted by OFF. In the illumination pattern of the light sources during the virtual image display illustrated in FIG. 6A, the light sources 14 that are arranged in two columns on the left and two columns on the right in the edge portion in the long-side direction (horizontal direction) of the light source circuit board 140 having a rectangular shape are turned off (denoted by OFF), and the light sources 14 that are arranged between the two columns on the left and the two columns on the right are turned on (denoted by ON). In contrast, in the illumination pattern of the light sources 14 during the real image display illustrated in FIG. 6B, the light sources 14 that are arranged in a mounting region in the lowermost row in a short-side direction (vertical direction) of the light source circuit board 140 having a rectangular shape are turned off (denoted by OFF), and the light sources 14 that are arranged in the other region are turned on (denoted by ON). The light sources 14 arranged in the mounting region in the lowermost row in FIG. 6B may be turned off as a measure against stray light, or the like.

### Effects of Embodiment

As described above, the head-up display device of the present embodiment is, for example, as illustrated in FIG. 1, the HUD device 1 that has the emission port 17 and emits display light L from the emission port 17 toward a light-transmissive member (windshield WS) and thereby causes a virtual image V1 and a real image V2 of a display image represented by the display light L to be visually recognized. The HUD device 1 is composed of the imaging optical system 2 that includes the display unit 11, the backlight 12 including the plurality of light sources 14, the first reflection member 22 having, as a polarization state, the first polarization state and the second polarization state different from each other in transmittance, and the second reflection member 23 reflecting the display light L1 transmitted through the first reflection member 22 and in which the first display light L1 in the first polarization state is emitted through the first optical path OP1 reflected by the surface of the first reflection member 22 and forms the virtual image V1 and the second display light L2 in the second polarization state is transmitted through the first reflection member 22, is emitted through the second optical path OP2 reflected by the second reflection member 23, and forms the real image V2, and the control unit 13 that controls the polarization state and controls the turning on and off of each of the plurality of light sources 14 of the backlight 12. When the virtual image V1 is displayed, the control unit 13 performs control so that at least one of the plurality of light sources 14 of the backlight 12 is turned on, and when the real image V2 is displayed, the control unit 13 performs control so that at least one of the plurality of light sources 14 of the backlight 12 is turned on and more power is consumed by the plurality of light sources 14 of the backlight 12 than when the virtual image V1 is displayed.

The HUD device 1 of the present embodiment includes the imaging optical system 2 that includes the first reflection member 22 having, as a polarization state, the first polarization state and the second polarization state different from each other in transmittance and the second reflection member 23 reflecting the display light transmitted through the first reflection member 22 and in which the first display light L1 in the first polarization state is emitted through the first optical path OP1 reflected by the surface of the first reflection member 22 and forms the virtual image V1 and the second display light L2 in the second polarization state is transmitted through the first reflection member 22, is emitted through the second optical path OP2 reflected by the second reflection member 23, and forms the real image V2, and the control unit 13 that controls the polarization state of the imaging optical system 2. When the virtual image V1 is displayed, the control unit 13 performs control so that at least one of the plurality of light sources 14 of the backlight 12 is turned on, and when the real image V2 is displayed, the control unit 13 performs control so that at least one of the plurality of light sources 14 of the backlight 12 is turned on and more power is consumed by the plurality of light sources 14 of the backlight 12 than when the virtual image V1 is displayed.

For example, in a case where LEDs are mounted as the plurality of light sources 14 of the backlight 12, the control unit 13 can achieve higher power efficiency by controlling the ON/OFF timing of each of the LEDs and the value (current value) of the current flowing through the LEDs and controlling the voltage supplied to the backlight 12 by an LED drive circuit (e.g., the light source driving unit 133 in FIG. 2). Thus, in the HUD device 1 that is capable of performing switching between the virtual image V1 display and the real image V2 display and in which the display unit 11 and the plurality of light sources 14 of the backlight 12 are used to perform the virtual image V1 display and the real image V2 display, by performing control so that more power is supplied to the backlight 12 when the display is switched from the virtual image V1 display to the real image V2 display, it is possible to achieve a small difference in brightness at the time of switching between the virtual image V1 display and the real image V2 display, ensuring appropriate luminance and uniformity ratio of illumination in both the virtual image display and the real image display. Furthermore, the small difference in brightness (luminance difference) at the time of switching from the virtual image V1 display to the real image V2 display can reduce the discomfort experienced by the occupant DR as a viewer.

In the HUD device 1 of the present embodiment, when the display is switched from the virtual image V1 display to the real image V2 display, the control unit 13 can control the value (current value) of the current flowing through the plurality of light sources 14 (e.g., LEDs) of the backlight 12 to increase the brightness of the backlight 12, achieving a small difference (minimizing the difference) in brightness between the virtual image V1 display and the real image V2 display without increasing the area of a region in which the plurality of light sources 14 of the backlight 12 are turned on. In particular, it is possible to achieve high luminance during the real image V2 display, thus ensuring appropriate luminance and uniformity ratio of illumination in both the virtual image display V1 and the real image display V2.

In the HUD device 1 of the present embodiment, when the display is switched from the virtual image V1 display to the real image V2 display, the control unit 13 can increase the number (area) of light sources 14 turned on of the backlight 12 mounted with the plurality of light sources 14, achieving a small difference (minimizing the difference) in brightness between the virtual image V1 display and the real image V2 display. In particular, it is possible to achieve high luminance during the real image V2 display, thus ensuring appropriate luminance and uniformity ratio of illumination in both the virtual image display V1 and the real image display V2.

In the HUD device 1 of the present embodiment, when the display is switched from the virtual image V1 display to the real image V2 display, the control unit 13 can control the value (current value) of the current flowing through the plurality of light sources 14 (e.g., LEDs) of the backlight 12 to increase the brightness of the backlight 12 and can increase the number (area) of light sources 14 turned on of the backlight 12 mounted with the plurality of light sources 14, further achieving a small difference (minimizing the difference) in brightness between the virtual image V1 display and the real image V2 display. In particular, it is possible to achieve high luminance during the real image V2 display, thus ensuring appropriate luminance and uniformity ratio of illumination in both the virtual image display V1 and the real image display V2.

The method of controlling a head-up display device of the present embodiment is, for example, as illustrated in FIG. 1, the method of controlling the HUD device 1 including the emission port 17, the imaging optical system 2 that includes the backlight 12 including the plurality of light sources 14 (see FIG. 4), the display unit 11 that transmits illumination light emitted by the light sources 14 and generates a display image, the first reflection member 22 having, as a polarization state, the first polarization state and the second polarization state different from each other in transmittance, and the second reflection member 23 reflecting the first display light L1 transmitted through the first reflection member 22 and in which the first display light L1 in the first polarization state is emitted through the first optical path OP1 reflected by the surface of the first reflection member 22 and forms the virtual image V1 and the second display light L2 in the second polarization state is transmitted through the first reflection member 22, is emitted through the second optical path OP2 reflected by the second reflection member 23, and forms the real image V2, and the control unit 13 that controls the polarization state and controls the turning on and off of each of the plurality of light sources 14 of the backlight 12.

The method includes, for example, as illustrated in FIG. 3, the step (ST102 or ST105) of controlling, by the control unit 13, the polarization state and switching the display light L to be emitted to the first display light L1 in the first polarization state or the second display light L2 in the second polarization state, the step (ST104) of performing control, by the control unit 13, so that at least one of the plurality of light sources 14 of the backlight 12 is turned on, when the first display light L1 in the first polarization state is emitted from the emission port 17 and the virtual image V1 is formed, and the step (ST107) of performing control, by the control unit 13, so that at least one of the plurality of light sources 14 of the backlight 12 is turned on and more power is consumed by the plurality of light sources 14 of the backlight 12 than when the virtual image V1 is formed, when the second display light L2 in the second polarization state is emitted from the emission port 17 and the real image V2 is formed.

The method of controlling the HUD device 1 of the present embodiment includes a control procedure (steps) in which the control unit 13 controls the polarization state of the imaging optical system 2 that includes the first reflection member 22 having, as a polarization state, the first polarization state and the second polarization state different from each other in transmittance and in which the first display light L1 in the first polarization state is emitted through the first optical path OP1 reflected by the surface of the first reflection member 22 and forms the virtual image V1 and the second display light L2 in the second polarization state is transmitted through the first reflection member 22, is emitted through the second optical path OP2 reflected by the second reflection member 23, and forms the real image V2. When the first display light L1 in the first polarization state is emitted and the virtual image V1 is formed, the control unit 13 performs control so that at least one of the plurality of light sources 14 of the backlight 12 is turned on, and when the second display light L2 in the second polarization state is emitted and the real image V2 is formed, the control unit 13 performs control so that at least one of the plurality of light sources 14 of the backlight 12 is turned on and more power is consumed by the plurality of light sources 14 of the backlight 12 than when the first display light L1 in the first polarization state is emitted and the virtual image V1 is formed.

Therefore, for example, in a case where LEDs are mounted as the plurality of light sources 14 of the backlight 12, the control unit 13 can achieve higher power efficiency by controlling the ON/OFF timing of each of the LEDs and the value (current value) of the current flowing through the LEDs and controlling the voltage supplied to the backlight 12 by an LED drive circuit (e.g., the light source driving unit 133 in FIG. 2). Thus, in the HUD device 1 that is capable of performing switching between the virtual image V1 display and the real image V2 display and in which the display unit 11 and the plurality of light sources 14 of the backlight 12 are used to perform the virtual image V1 display and the real image V2 display, by performing control so that more power is supplied to the backlight 12 when the display is switched from the virtual image V1 display to the real image V2 display, it is possible to achieve a small difference in brightness at the time of switching between the virtual image V1 display and the real image V2 display, ensuring appropriate luminance and uniformity ratio of illumination in both the virtual image V1 display and the real image display V2. Furthermore, the small difference in brightness (luminance difference) at the time of switching from the virtual image V1 display to the real image V2 display can reduce the discomfort experienced by the occupant DR as a viewer.

In the embodiment described above, the windshield WS is used as a light-transmissive member; however flat glass or a combiner may be used.

The present invention is not limited to the exemplary embodiment described above, and those skilled in the art can easily modify the exemplary embodiment within the scope of the claims.

### REFERENCE SIGNS LIST

1 Head-up display device (HUD device)
2 Imaging optical system
10 Picture generation unit (PGU)
11 Display unit
12 Backlight
13 Control unit
14 Light source
17 Emission port
20 Switch
21 Lenticular lens
22 First reflection member
23 Second reflection member
24 Third reflection member
30 Various devices
111 Display element
112 Switching element
131 Display control unit
132 Display driving unit
133 Light source driving unit
140 Light source circuit board
V1 Virtual image V2 Real image
L (L1, L2) Display light
L1 First display light
L2 Second display light
OP1 First optical path
OP2 Second optical path

1. A head-up display device that has an emission port and emits display light from the emission port toward a light-transmissive member and thereby causes a virtual image and a real image of a display image represented by the display light to be visually recognized, the head-up display device comprising:
an imaging optical system that includes a display unit, a backlight including a plurality of light sources, a first reflection member having, as a polarization state, a first polarization state and a second polarization state different from each other in transmittance, and a second reflection member reflecting the display light transmitted through the first reflection member and in which first display light in the first polarization state is emitted through a first optical path reflected by a surface of the first reflection member and forms the virtual image and second display light in the second polarization state is transmitted through the first reflection member, is emitted through a second optical path reflected by the second reflection member, and forms the real image; and
a control unit that controls the polarization state and controls turning on and off of each of the plurality of light sources of the backlight, wherein
when the virtual image is displayed, the control unit performs control so that at least one of the plurality of light sources of the backlight is turned on, and when the real image is displayed, the control unit performs control so that at least one of the plurality of light sources of the backlight is turned on and more power is consumed by the plurality of light sources of the backlight than when the virtual image is displayed.

2. The head-up display device according to claim 1, wherein
when the real image is displayed, the control unit performs control so that a value of a current flowing through the plurality of light sources of the backlight is increased.

3. The head-up display device according to claim 1, wherein
when the real image is displayed, the control unit performs control so that a number of light sources turned on of the plurality of light sources of the backlight is increased.

4. The head-up display device according to claim 1, wherein
when the real image is displayed, the control unit performs control so that a value of a current flowing through the plurality of light sources of the backlight is increased and performs control so that a number of light sources turned on of the plurality of light sources of the backlight is increased.

5. A method of controlling a head-up display device including
an emission port,
an imaging optical system that includes a backlight including a plurality of light sources, a display unit that transmits illumination light emitted by the light sources and generates a display image, a first reflection member having, as a polarization state, a first polarization state and a second polarization state different from each other in transmittance, and a second reflection member reflecting display light transmitted through the first reflection member and in which first display light in the first polarization state is emitted through a first optical path reflected by a surface of the first reflection member and forms a virtual image and second display light in the second polarization state is transmitted through the first reflection member, is emitted through a second optical path reflected by the second reflection member, and forms a real image, and
a control unit that controls the polarization state and controls turning on and off of each of the plurality of light sources of the backlight, the method comprising:
a step of controlling, by the control unit, the polarization state and switching the display light to be emitted to the first display light in the first polarization state or the second display light in the second polarization state;
a step of performing control, by the control unit, so that at least one of the plurality of light sources of the backlight is turned on, when the first display light in the first polarization state is emitted from the emission port and the virtual image is formed; and
a step of performing control, by the control unit, so that at least one of the plurality of light sources of the backlight is turned on and more power is consumed by the plurality of light sources of the backlight than when the virtual image is formed, when the second display light in the second polarization state is emitted from the emission port and the real image is formed.
